(19) United States
(12) Patent Application Publication
(10) Pub. No.: US 2008/0025449 A1
(43) Pub. Date: Jan. 31, 2008

(54) Dual Mode Sync Generator in an Atsc-Dtv Receiver

(76) Inventors: Ivonete Markman, Carmel, IN (US); Gabriel Alfred Edde, Indianapolis, IN (US)

Correspondence Address: THOMSON LICENSING LLC, Two Independence Way, Suite 200, PRINCETON, NJ, 08540, US

(21) Appl. No.: 11/579,967

(22) PCT Filed: May 11, 2005
(86) PCT No.: PCT/US05/16448

§ 371 Date: Nov. 10, 2006

Related U.S. Application Data
(60) Provisional application No. 60/570,423, filed on May 12, 2004.

(51) Int. Cl. H04N 5/44; H04L 27/22; H04L 7/02; H04L 7/04

(52) U.S. Cl. 375/359

(57) ABSTRACT

A receiver comprises a sync generator for providing a synchronization signal, wherein the sync generator comprises at least two modes of operation, wherein in a first mode of operation the sync generator generates the synchronization signal as a function of a channel virtual center signal and in a second mode of operation the dual-mode sync generator generates the synchronization signal as a function of a correlation signal.

### BACKGROUND OF THE INVENTION

The present invention generally relates to communications systems and, more particularly, to a receiver.

In modern digital communication systems like the ATSC-DTV (Advanced Television Systems Committee-Digital Television) system (e.g., see, United States Advanced Television Systems Committee, “ATSC Digital Television Standard”, Document A/53, Sep. 16, 1995 and “Guide to the Use of the ATSC Digital Television Standard”, Document A/54, Oct. 4, 1995), advanced modulation, channel coding and equalization are usually applied. In the receiver, demodulators generally have carrier phase and/or symbol timing ambiguity. Equalizers are generally a DFE (Decision Feedback Equalizer) type or some variation of it and have a finite length. In severely distorted channels, it is important to know the virtual center of the channel impulse response to give the equalizer the best chance of successfully processing the signal and correcting for distortion. One approach is to use a centroid calculator that calculates the channel virtual center for an adaptive equalizer based on a segment synchronization (sync) signal. Another approach is to use a centroid calculator that calculates the channel virtual center for an adaptive equalizer based on a frame sync signal.

Once the channel virtual center is determined, the reference signals, such as the segment sync signal and the frame sync signal, are locally re-generated in the receiver to line up at the virtual center. As a result, taps will grow in the equalizer to equalize the channel such that the equalized data output will be lined up at the virtual center.

Besides the use of a centroid calculator, other known approaches to the regeneration of the segment sync signal and/or field sync signal are based on the use of correlation only. For example, for the segment sync signal the receiver includes a correlator that correlates the received demodulated signal to the four symbol segment sync pattern. The receiver then regenerates the segment sync signal upon detection by the correlator of the segment sync pattern in the received demodulated signal.

### SUMMARY OF THE INVENTION

In accordance with the principles of the invention, a receiver comprises a sync generator for providing a synchronization signal, wherein the sync generator comprises at least two modes of operation, wherein in a first mode of operation the sync generator generates the synchronization signal as a function of a channel virtual center signal and in a second mode of operation the dual-mode sync generator generates the synchronization signal as a function of a correlation signal.

In an embodiment of the invention, an ATSC receiver comprises a demodulator, a centroid calculator and a dual-mode sync generator. The demodulator demodulates a received ATSC-DTV signal and provides a demodulated signal. The centroid calculator processes the demodulated ATSC-DTV signal based on the segment sync signal and provides a channel virtual center signal and a correlation signal to the dual-mode sync generator. The latter has at least two modes of operation, wherein in a first mode of operation the dual-mode sync generator generates the segment sync signal as a function of the channel virtual center signal and in a second mode of operation the dual-mode sync generator generates the segment sync signal as a function of the correlation signal.

### BRIEF DESCRIPTION OF THE DRAWINGS

FIG. 1 shows a block diagram of a centroid calculator;

FIG. 2 shows a block diagram of a segment sync generator;

FIG. 3 shows a block diagram for processing a complex signal for use in a complex centroid calculator;

FIG. 4 shows an illustrative high-level block diagram of a receiver embodying the principles of the invention;

FIG. 5 shows an illustrative portion of a receiver embodying the principles of the invention;

FIGS. 6 and 7 show illustrative flow charts in accordance with the principles of the invention;

FIG. 8 shows another embodiment in accordance with the principles of the invention;

FIGS. 9 and 10 show illustrative flow charts in accordance with the principles of the invention;

FIG. 11 shows another embodiment in accordance with the principles of the invention; and

FIGS. 12 and 13 show illustrative flow charts in accordance with the principles of the invention.

### DETAILED DESCRIPTION

Other than the inventive concept, the elements shown in the figures are well known and will not be described in detail. Also, familiarity with television broadcasting and receivers is assumed and is not described in detail herein. For example, other than the inventive concept, familiarity with current and proposed recommendations for TV standards such as NTSC (National Television Systems Committee), PAL (Phase Alternation Lines), SECAM (SEquential Couleur Avec Memoire) and ATSC (Advanced Television Systems Committee) (ATSC) is assumed. Likewise, other than the inventive concept, transmission concepts such as eight-level vestigial sideband (8-VSB), Quadrature Amplitude Modulation (QAM), and receiver components such as a radio-frequency (RF) front-end, or receiver section, such as a low noise block, tuners, demodulators, correlators, leak integrators and squarers is assumed. Similarly, formatting and encoding methods (such as Moving Picture Expert Group (MPEG)-2 Systems Standard (ISO/IEC 13818-1)) for generating transport bit streams are well-known and not described herein. It should also be noted that the inventive concept may be implemented using conventional programming techniques, which, as such, will not be described herein. Finally, like-numbers on the figures represent similar elements.

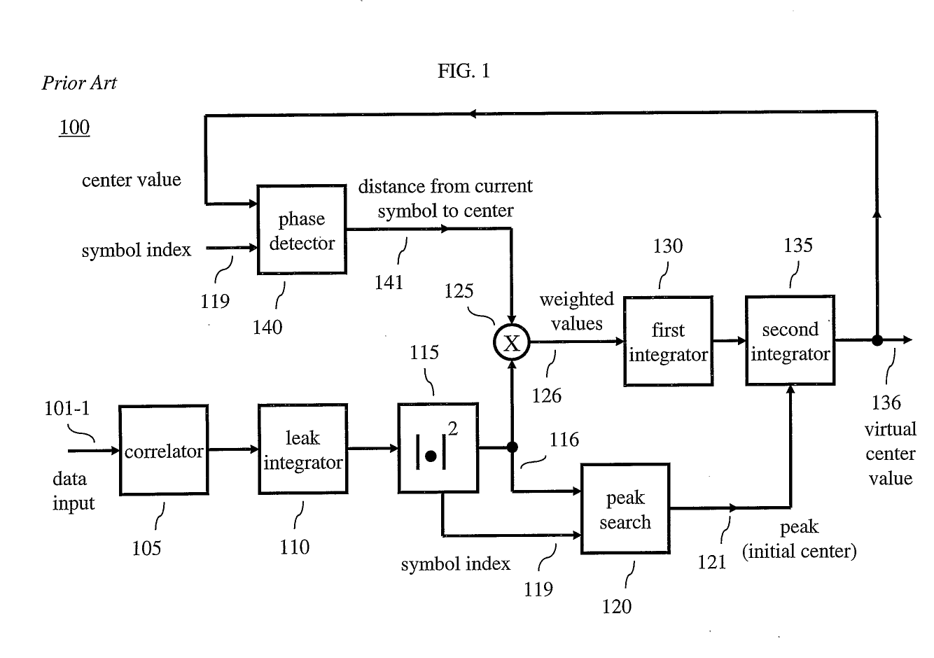

Before describing the inventive concept, a block diagram of a centroid calculator 100 is shown in FIG. 1 for use in an ATSC-DTV system. Centroid calculator 100 comprises correlator 105, leak integrator 110, squarer 115, peak search element 120, multiplier 125, first integrator 130, second integrator 135 and phase detector 140. Centroid calculator 100 is based on the segment sync signal, one sample-per-symbol and a data input signal 101-1 comprising only the in-phase (real) component. The data input signal 101-1 represents a demodulated received ATSC-DTV signal provided by a demodulator (not shown).

The data input signal 101-1 is applied to correlator 105 (or segment sync detector 105) for detection of the segment sync signal (or pattern) therein. The segment sync signal has a repetitive pattern and the distance between two adjacent segment sync signals is rather large (832 symbols). As such, the segment sync signal can be used to estimate the channel impulse response, which in turn is used to estimate the channel virtual center or centroid. Segment sync detector 105 correlates data input signal 101-1 against the characteristic of the ATSC-DTV segment sync, that is, [1 0 0 1] in binary representation, or [+5 −5 −5 +5] in VSB symbol representation. The output signal from segment sync detector 105 is then applied to leak integrator 110. The latter has a length of 832 symbols, which equals the number of symbols in one segment. Since the VSB data is random, the integrator values at data symbol positions will be averaged towards zero. However, since the four segment sync symbols repeat every 832 symbols, the integrator value at a segment sync location will grow proportionally to the signal strength. If the channel impulse response presents multipath or ghosts, the segment sync symbols will appear at those multipath delay positions. As a result, the integrator values at the multipath delay positions will also grow proportionally to the ghost amplitude. The leak integrator is such that, after a peak search is performed, it subtracts a constant value every time the integrator adds a new number. This is done to avoid hardware overflow. The 832 leak integrator values are squared by squarer 115. The resultant output signal, or correlator signal 116, is sent to peak search element 120 and multiplier 125. (It should be noted that instead of squaring, element 115 may provide the absolute value of its input signal.)

As each leak integrator value (correlator signal 116) is applied to peak search element 120, the corresponding symbol index value (symbol index 119) is also applied to peak search element 120. The symbol index 119 is a virtual index that may be originally reset at zero and is incremented by one for every new leak integrator value, repeating a pattern from 0 to 831. Peak search element 120 performs a peak search over the 832 squared integrator values (correlator signal 116) and provides peak signal 121, which corresponds to the symbol index associated with the maximum value among the 832 squared integrator values. The peak signal 121 is used as the initial center of the channel and is applied to second integrator 135 (described below).

The leak integrator values (correlator signal 116) are also weighted by the relative distance from the current symbol index to the initial center and a weighted center position is then determined by a feedback loop, or centroid calculation loop. The centroid calculation loop comprises phase detector 140, multiplier 125, first integrator 130 and second integrator 135. This feedback loop starts after the peak search is performed and second integrator 135 is initialized with the initial center or peak value. Phase detector 140 calculates the distance (signal 141) between the current symbol index (symbol index 119) and the virtual center value 136. The weighted values 126 are calculated via multiplier 125 and are fed to first integrator 130, which accumulates the weighted values for every group of 832 symbols. As noted above, second integrator 135 is initially set to the peak value and then proceeds to accumulate the output of first integrator 130 to create the virtual center value, or centroid, 136. All integrators in FIG. 1 have implicit scaling factors.

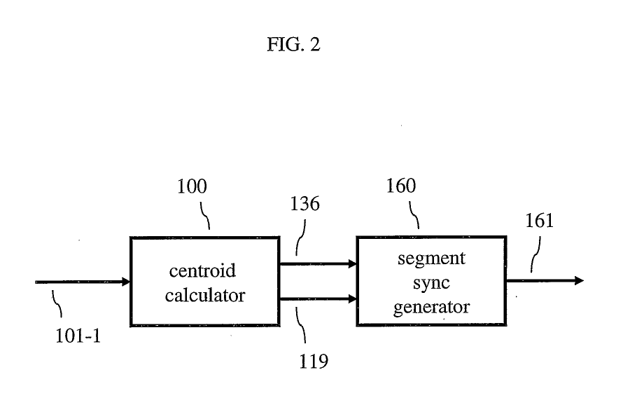

Once the virtual center value 136 is determined, the VSB reference signals, such as the segment sync and the frame sync signal, are locally re-generated in the receiver to line up at the virtual center. As a result, taps will grow in the equalizer to equalize the channel such that the equalized data output will be lined up at the virtual center. FIG. 2 shows a block diagram for segment sync regeneration based on the virtual center. In particular, segment sync generator 160 receives the above-described virtual center value 136 and the symbol index 119 from centroid calculator 100 and provides segment sync signal 161 in response thereto. For example, segment sync signal 161 has a value of “1” when symbol index 119 coincides with virtual center value 136 and has a value of “0” otherwise. Alternately, segment sync signal 161 may have a value of “1” during the four subsequent values of symbol index starting with the center value, and have a value of “0” otherwise.

Extensions of the system described above with respect to FIG. 1 to a complex data input signal (in-phase and quadrature components), two samples per symbol or to a frame sync based design are easily derived from FIG. 1.

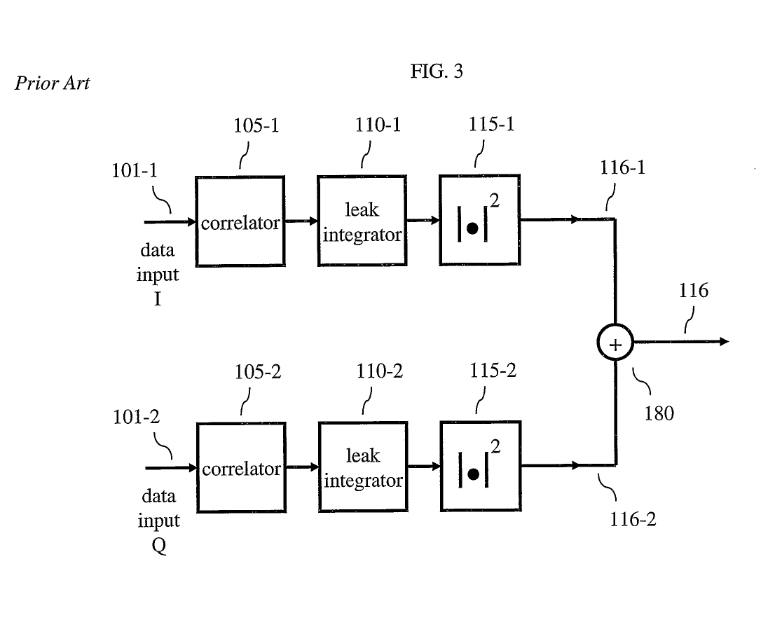

For example, if the data input signal is complex, the centroid calculator (now also referred to as a “complex centroid calculator”) separately processes the in-phase (I) and quadrature (Q) components of the input data signal as shown in FIG. 3. In particular, the in-phase component (101-1) of the input data signal is processed via segment sync detector 105-1, leak integrator 110-1 and squarer 115-1; while the quadrature component (101-2) of the input data signal is processed via segment sync detector 105-2, leak integrator 110-2 and squarer 115-2. Each of these elements function in a similar fashion to those described above in FIG. 1. Although not shown in the figure, the symbol index can be generated from either squarer element. The output signals from each squarer (115-1 and 115-2) are added together via adder 180 to provide correlator signal 116 and the remainder of the processing is the same as described above with respect to FIG. 1.

With respect to a two-sample-per-symbol centroid calculator, T/2 spacing is illustratively used (where T corresponds to the symbol interval). For example, the segment sync detector has T/2 spaced values that match with a T/2 spaced segment sync characteristic, the leak integrators are 2×832 long and the symbol index follows the pattern 0, 0, 1, 1, 2, 2, . . . , 831, 831, instead of 0, 1, 2, . . . , 831.

Finally, for a centroid calculator based on the frame sync signal, the following should be noted. Since the frame/field sync signal is composed of 832 symbols and arrives every 313 segments this is longer than any practical multipath spread in a channel, hence, there is no problem in determining the position of any multipath signals. An asynchronous PN511 correlator may be used to measure the channel impulse response (if using the PN511 alone, out of the 832 frame sync symbols), as opposed to the segment sync detector in FIG. 1. (PN511 is a pseudo-random number sequence and described in the earlier-noted ATSC standard.) The additional processing is similar to that described above for FIG. 1 except that the processing is performed for the duration of at least one entire field. The correlation values are sent to the peak search function block to perform a peak search over one field time. The symbol index of this peak value is thus to be used as the initial virtual center point. Once the initial center point is determined, then the correlation results are analyzed only when a correlation output is above a pre-determined threshold and within a certain range before and after the initial virtual center point. For example, ±500 symbols around the initial center position that the correlation output is above the pre-determined values. The exact range is determined by both the practical channel impulse response length that is expected to be encountered in a real environment and the length of the available equalizer. The remainder of the processing is the same as described earlier for FIG. 1.

Turning now to the inventive concept, a receiver comprises a sync generator for providing a synchronization signal, wherein the sync generator comprises at least two modes of operation, wherein in a first mode of operation the sync generator generates the synchronization signal as a function of a channel virtual center signal and in a second mode of operation the dual-mode sync generator generates the synchronization signal as a function of a correlation signal. For illustration purposes only, the inventive concept will be described in the context of an ATSC segment sync signal. However, the inventive concept is not so limited.

It should be noted that the inventive concept may be used in conjunction with an equalizer to speed up receiver response. The idea is based on the fact that for many channel impulse responses, the corresponding virtual center position is relatively close to the main signal, that is, the signal with maximum strength or peak. However, the virtual center calculation can only be performed after demodulator convergence and the equalizer is only started after the channel center value is identified. Unfortunately, this may increase receiver acquisition time. Therefore, and in accordance with the principles of the invention, use of a correlation signal signifying detection of the synchronization signal enables the receiver to start the equalizer as soon as the peak search is performed but before determination of the channel virtual center. This assumes that the virtual center is the main signal or peak. Once the virtual center calculation is completed, a decision can then be made whether to restart the equalizer with the new virtual center, or to proceed the processing with the original peak. This decision may be based, for example, on whether the peak and the center value positions are within a threshold distance, or whether the equalizer has already converged. For many channel impulse responses this early start on equalization will represent savings on convergence time and overall receiver acquisition time. Even if a decision is made to use the virtual center once it is available, the equalizer can be reset without any penalty compared to the original strategy of waiting for the center value calculation.

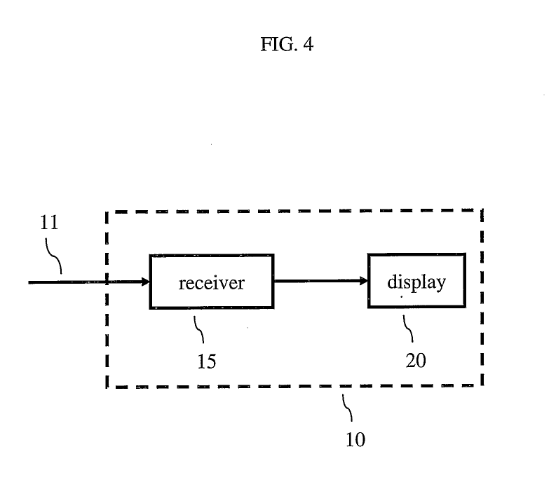

A high-level block diagram of an illustrative television set 10 in accordance with the principles of the invention is shown in FIG. 4. Television (TV) set 10 includes a receiver 15 and a display 20. Illustratively, receiver 15 is an ATSC-compatible receiver. It should be noted that receiver 15 may also be NTSC (National Television Systems Committee)-compatible, i.e., have an NTSC mode of operation and an ATSC mode of operation such that TV set 10 is capable of displaying video content from an NTSC broadcast or an ATSC broadcast. For simplicity in describing the inventive concept, only the ATSC mode of operation is described herein. Receiver 15 receives a broadcast signal 11 (e.g., via an antenna (not shown)) for processing to recover therefrom, e.g., an HDTV (high definition TV) video signal for application to display 20 for viewing video content thereon.

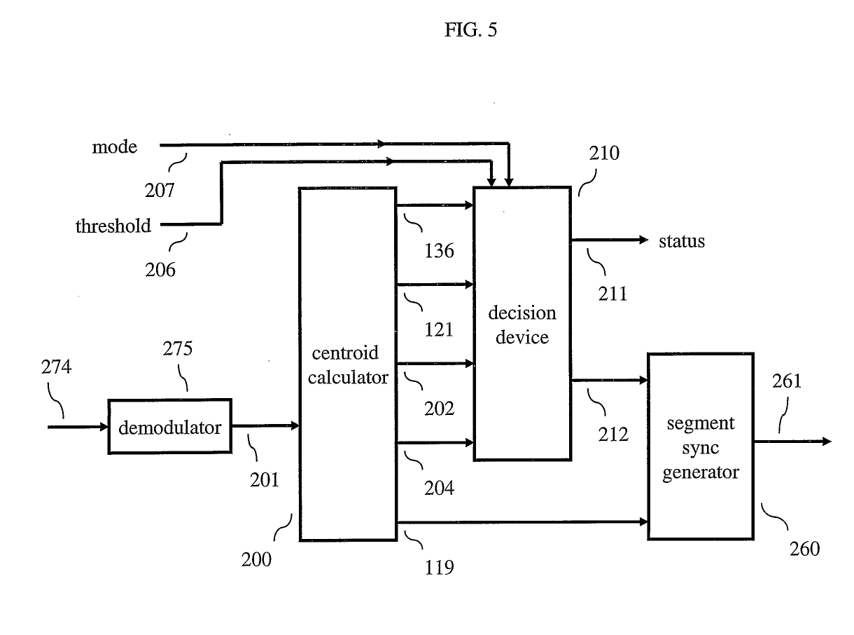

In accordance with the principles of the invention, receiver 15 includes a dual-mode sync generator that has at least two modes of operation, wherein in a first mode of operation the dual-mode sync generator generates the segment sync signal as a function of a virtual center signal and in a second mode of operation the dual-mode sync generator generates the segment sync signal as a function of a correlation signal. An illustrative block diagram of the relevant portion of receiver 15 is shown in FIG. 5. (It should be noted that other processing blocks of receiver 15 not relevant to the inventive concept are not shown herein, e.g., an RF front end for providing signal 274, etc.) A demodulator 275 receives a signal 274 that is centered at an IF frequency (F_{IF}) and has a bandwidth equal to 6 MHz (millions of hertz). Demodulator 275 provides a demodulated received ATSC-DTV signal 201 to centroid calculator 200. The latter is similar to centroid calculator 100 of FIG. 1 and provides a virtual center value 136, a symbol index 119 and a peak signal 121. It should be noted that peak signal 121 is representative of a signal conveying correlation data, i.e., a correlation signal. However, other signals can be used, e.g., signal 116 of FIG. 1, etc. In addition to the above-mentioned signals, centroid calculator 200 also provides a number of additional signals. First, centroid calculator 200 provides a calculation flag signal 202, which identifies when the centroid calculation is complete. For example, calculation flag signal 202 may be set to a value of “1” once the calculation is complete and set to a value of “0” beforehand. Finally, centroid calculator 200 provides peak flag signal 204, which identifies when the peak search is complete. For example, peak flag signal 204 may be set to a value of “1” once the peak search calculation is done and set to a value of “0” beforehand.

Centroid calculator 200 provides the above-mentioned output signals 136, 121, 202 and 204 to decision device 210 (described below). In accordance with the principles of the invention, decision device 210 generates a segment reference signal 212 to segment sync generator 260, which is similar to the earlier described segment sync generator 160 of FIG. 2. In particular, segment sync generator 260 receives segment reference signal 212 from decision device 210 and the symbol index 119 from centroid calculator 200 and provides segment sync signal 261 in response thereto. For example, segment sync signal 261 has a value of “1” when symbol index 119 coincides with segment reference signal 212 and has a value of “0” otherwise. In accordance with the principles of the invention, segment sync signal 261 is generated either as a function of the virtual center value 136 or the peak signal 121.

Turning back to decision device 210, this device receives virtual center value 136, peak signal 121, calculation flag signal 202 and peak flag signal 204 from centroid calculator 200. In addition, decision device 210 also receives two control signals, a threshold signal 206 and a mode signal 207 (e.g., from a processor (not shown) of receiver 15). Illustratively, there are three modes of operation, but the inventive concept is not so limited. In a first mode of operation, e.g., mode signal 207 is set equal to a value of “0”, only a correlation signal is used for generating the segment sync signal. In a second mode of operation, e.g., mode signal 207 is set equal to a value of “1”, only a virtual center value is used for generating the segment sync signal. Finally, in the third mode of operation, e.g., mode signal 207 is set equal to a value of “2”, either the correlation signal or the virtual center value is used for generating the segment sync signal. Finally, decision device 210 provides the above-noted segment reference signal 212 and also provides a status signal 211 for use by other portions (not shown) of receiver 15.

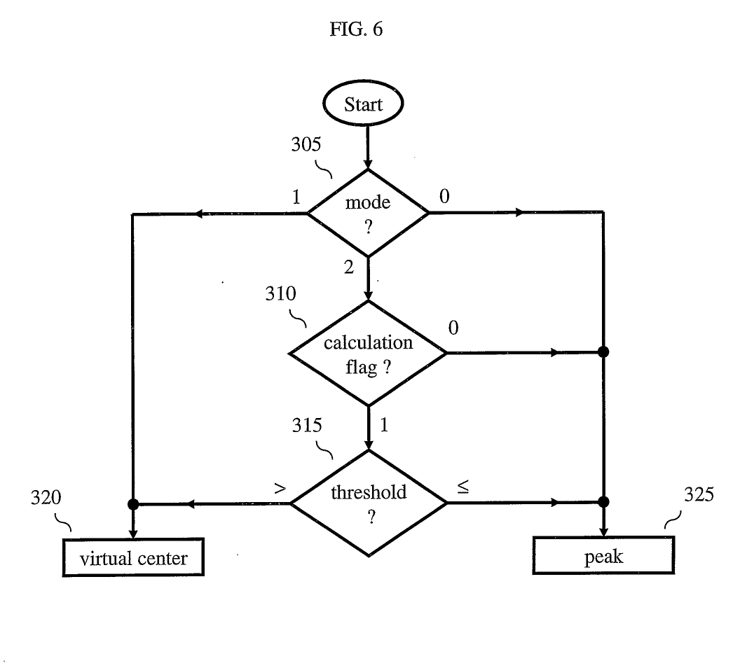

In accordance with the principles of the invention, decision device 210 provides segment reference signal 212 as illustrated in the flow chart of FIG. 6. It should be noted that although the principles of the invention are described herein in the context of flow charts, other representations could also be used, e.g., state diagrams. In step 305, decision device 210 determines the current mode of operation from mode signal 207. If mode signal 207 is representative of a value of “0”, then decision device 210 provides peak signal 121 as segment reference signal 212 in step 325. On the other hand, if mode signal 207 is representative of a value of “1”, then decision device 210 provides virtual center value 136 as segment reference signal 212 in step 320. Finally, if mode signal 207 is representative of a value of “2”, then decision device 210 evaluates the calculation flag signal 202 in step 310. If the value of calculation flag signal 202 is equal to “0”, e.g., centroid calculator 200 has not yet finished determining the virtual center value, then decision device 210 provides peak signal 121 as segment reference signal 212 in step 325. However, once the value of calculation flag signal 202 becomes equal to “1”, then decision device 210 evaluates the distance between the correlation value and the determined virtual center value in step 315. If the |peak−center value|≦threshold (conveyed via threshold signal 206), then decision device 210 provides peak signal 121 as segment reference signal 212 in step 325. In this case, the peak is within the threshold distance from the virtual center value. However if the |peak−center value″>threshold, then decision device 210 provides virtual center value 136 as segment reference signal 212 in step 320. In this case, the peak is greater than the threshold distance from the virtual center value.

As noted above, decision device 210 also provides status signal 211. This signal identifies to other portions (not shown) of receiver 15 whether the segment reference is derived from the peak or the virtual center value and may be used to reset subsequent receiver blocks like an equalizer (not shown). For example, an equalizer can be reset whenever status signal 211 transitions from a value of “0” to a value of “1”, a value of “0” to a value of “2”, a value of “0” to a value of “3” and a value of “1” to a value of “3”.

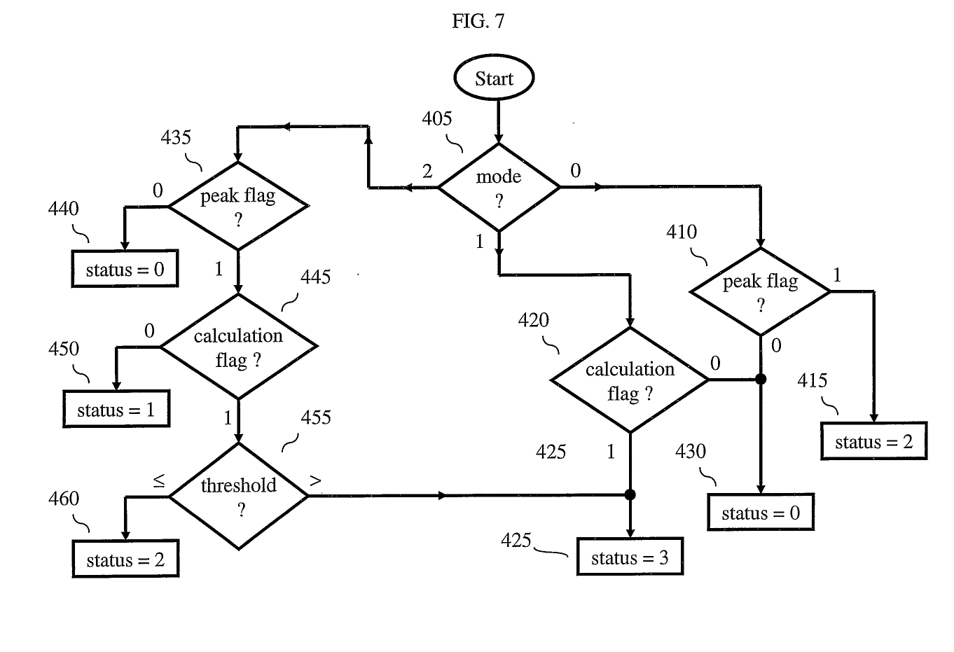

In accordance with the principles of the invention, decision device 210 provides status signal 211 as illustrated in the flow chart of FIG. 7. Like the flow chart shown in FIG. 6, decision device 210 first determines the mode of operation in step 405. If mode signal 207 is representative of a value of “0”, (peak signal 121 is being used to generate segment reference signal 212) then decision device 210 evaluates peak flag signal 204 in step 410. If the value of peak flag signal 204 is equal to a “1”, i.e., the peak search is complete, then decision device 210 sets status signal 211 to a value of “2” in step 415. However, if the value of peak flag signal 204 is equal to a “0”, i.e., the peak search is not complete, then decision device 210 sets status signal 211 to a value of “0” in step 430. On the other hand, if mode signal 207 is representative of a value of “1”, (virtual center value 136 is being used to generate segment reference signal 212) then decision device 210 evaluates calculation flag signal 202 in step 420. If the value of calculation flag signal 202 is equal to a “1”, i.e., the calculation is complete, then decision device 210 sets status signal 211 to a value of “3” in step 425. However, if the value of calculation flag signal 202 is equal to a “0”, i.e., the calculation is not complete, then decision device 210 sets status signal 211 to a value of “0” in step 430. Finally, if mode signal 207 is representative of a value of “2”, (either peak signal 121 or virtual center value 136 is used for generating the segment sync signal) then decision device 210 evaluates peak flag signal 204 in step 435. If the value of peak flag signal 204 is equal to a “0”, i.e., the peak search is not complete, then decision device 210 sets status signal 211 to a value of “0” in step 440. However, if the value of peak flag signal 204 is equal to a “1”, i.e., the peak search is complete, then decision device 210 evaluates calculation flag 202 in step 445. If the value of calculation flag signal 202 is equal to a “0”, i.e., the calculation is not complete, then decision device 210 sets status signal 211 to a value of “1” in step 450. However, if the value of calculation flag signal 202 is equal to a “1”, i.e., the calculation is complete, then decision device 210 evaluates the distance between the peak value and the determined virtual center value in step 455. If the |peak−center value|≦threshold (conveyed via threshold signal 206), then decision device 210 sets status signal 211 to a value of “2” in step 460. However if the |peak−center value|>threshold, then decision device 210 sets status signal 211 to a value of “3” in step 425.

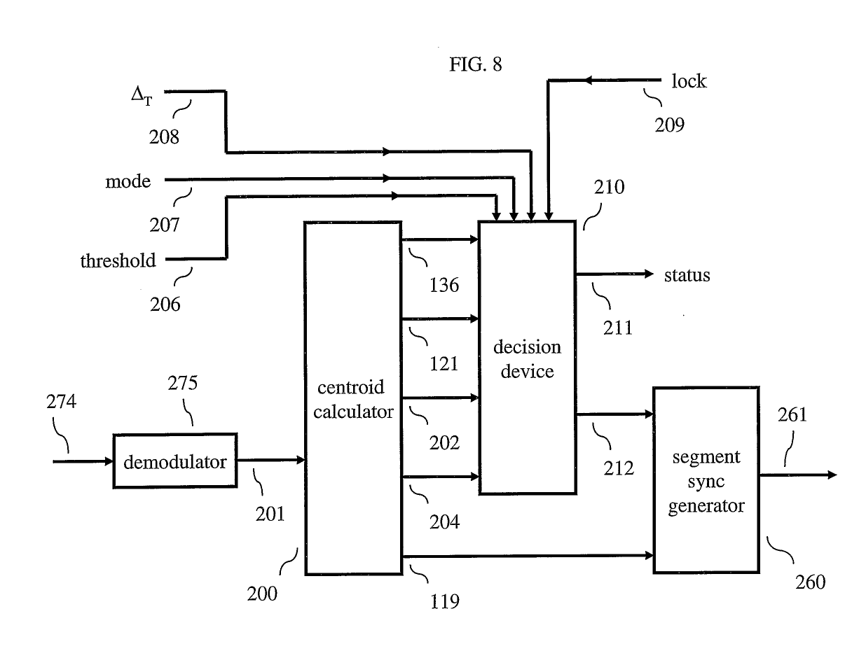

Turning now to FIG. 8, another illustrative embodiment in accordance with the principles of the invention is shown. The embodiment shown in FIG. 8 is similar to that shown in FIG. 5 except that decision device 210 accepts two additional input signals. The first input signal is lock signal 209, which conveys status of, e.g., an equalizer of receiver 15, and whether the equalizer is locked or not. Lock signal 209 may come from the equalizer, another receiver block or it may be a programmable bit register controlled by a processor (all not shown in FIG. 8). The other input signal is Δ_{T} 208, the value of which is representative of the occurrence, or passing, of a period of time (described below). Illustratively, Δ_{T} 208 is provided from a programmable register controlled by a processor (not shown) of receiver 15 and is representative of a time interval, Δ_{T}≧0.

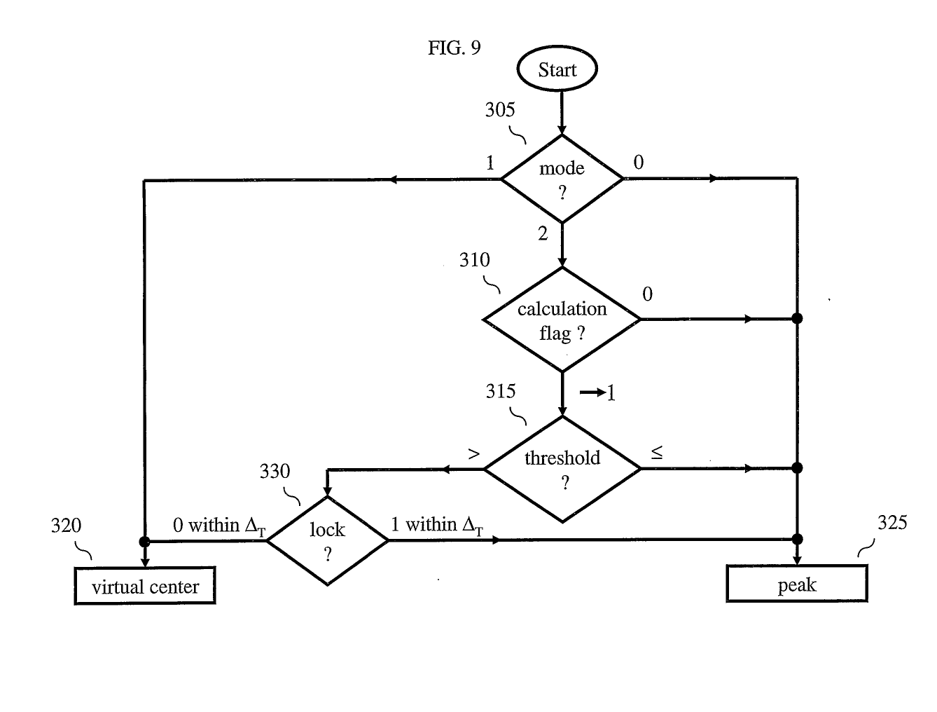

In this embodiment, decision device 210 provides segment reference signal 212 as illustrated in the flow chart of FIG. 9. This flow chart is similar to the flow chart shown in FIG. 6. In step 305 of FIG. 9, decision device 210 determines the current mode of operation from mode signal 207. If mode signal 207 is representative of a value of “0”, then decision device 210 provides peak signal 121 as segment reference signal 212 in step 325. On the other hand, if mode signal 207 is representative of a value of “1”, then decision device 210 provides virtual center value 136 as segment reference signal 212 in step 320. Finally, if mode signal 207 is representative of a value of “2”, then decision device 210 evaluates the calculation flag signal 202 in step 310. If the value of calculation flag signal 202 is equal to “0”, e.g., centroid calculator 200 has not yet finished determining the virtual center value, then decision device 210 provides peak signal 121 as segment reference signal 212 in step 325. However, once the value of calculation flag signal 202 transitions to “1”, (a transition to “1” is represented by the symbol “→1” in FIG. 9), i.e., the calculation is now complete, then decision device 210 evaluates the distance between the correlation value and the determined virtual center value in step 315. If the |peak−center value|≦threshold (conveyed via threshold signal 206), then decision device 210 provides peak signal 121 as segment reference signal 212 in step 325. In this case, the peak is within the threshold distance from the virtual center value. However if the |peak−center value|>threshold, then decision device 210 evaluates lock signal 209 in step 330. If the value of lock signal 209 is equal to a “1” and occurs within the Δ_{T} 208 time period (e.g., the equalizer has locked within this time period, which may start being computed as the calculation flag signal 202 transitions to “1”) then decision device 210 provides peak signal 121 as segment reference signal 212 in step 325. However, if the value of lock signal 209 is equal to a “0” and occurs within the Δ_{T} 208 time period (the equalizer has not yet locked within the time period) then decision device 210 provides virtual center value 136 as segment reference signal 212 in step 320.

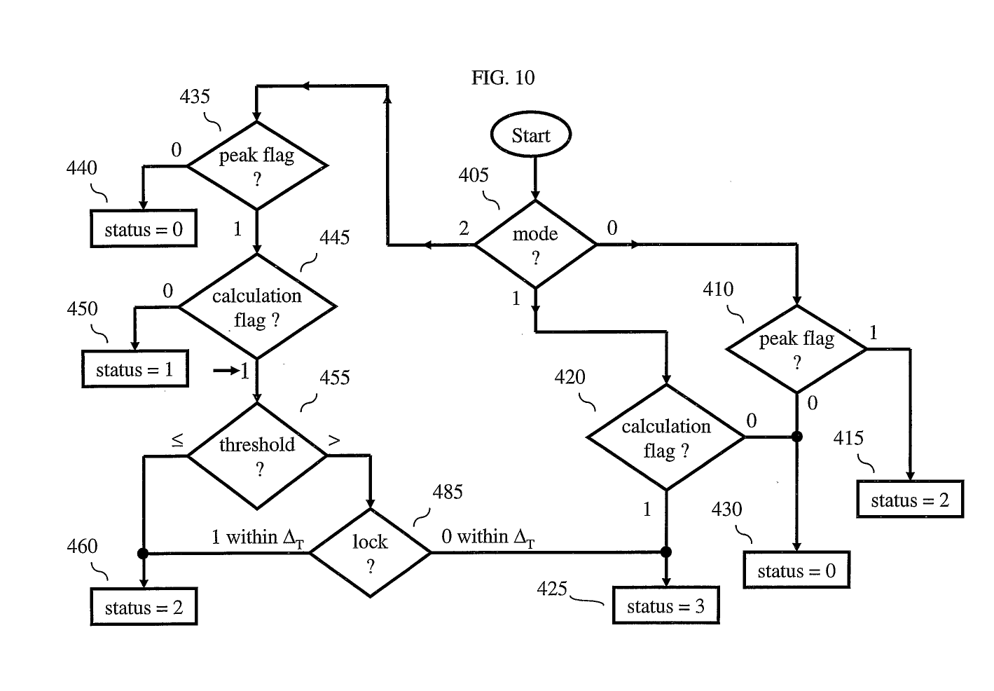

Referring now to FIG. 10, decision device 210 provides status signal 211 as illustrated in the flow chart shown therein. This flow chart is similar to the flow chart shown in FIG. 7. Decision device 210 first determines the mode of operation in step 405. If mode signal 207 is representative of a value of “0”, (peak signal 121 is being used to generate segment reference signal 212) then decision device 210 evaluates peak flag signal 204 in step 410. If the value of peak flag signal 204 is equal to a “1”, i.e., the peak search is complete, then decision device 210 sets status signal 211 to a value of “2” in step 415. However, if the value of peak flag signal 204 is equal to a “0”, i.e., the peak search is not complete, then decision device 210 sets status signal 211 to a value of “0” in step 430. On the other hand, if mode signal 207 is representative of a value of “1”, (virtual center value 136 is being used to generate segment reference signal 212) then decision device 210 evaluates calculation flag signal 202 in step 420. If the value of calculation flag signal 202 is equal to a “1”, i.e., the calculation is complete, then decision device 210 sets status signal 211 to a value of “3” in step 425. However, if the value of calculation flag signal 202 is equal to a “0”, i.e., the calculation is not complete, then decision device 210 sets status signal 211 to a value of “0” in step 430. Finally, if mode signal 207 is representative of a value of “2”, (either peak signal 121 or virtual center value 136 is used for generating the segment sync signal) then decision device 210 evaluates peak flag signal 204 in step 435. If the value of peak flag signal 204 is equal to a “0”, i.e., the peak search is not complete, then decision device 210 sets status signal 211 to a value of “0” in step 440. However, if the value of peak flag signal 204 is equal to a “1”, i.e., the peak search is complete, then decision device 210 evaluates calculation flag 202 in step 445. If the value of calculation flag signal 202 is equal to a “0”, i.e., the calculation is not complete, then decision device 210 sets status signal 211 to a value of “1” in step 450. However, once the value of calculation flag signal 202 transitions to “1”, (a transition to “1” is represented by the symbol “→1” in FIG. 10), i.e., the calculation is now complete, then decision device 210 evaluates the distance between the peak value and the determined virtual center value in step 455. If the |peak−center value|≦threshold (conveyed via threshold signal 206), then decision device 210 sets status signal 211 to a value of “2” in step 460. However if the |peak−center value|>threshold, then decision device 210 evaluates lock signal 209 in step 485. If the value of lock signal 209 is equal to a “1” and occurs within the Δ_{T} 208 time period (e.g., the equalizer has locked within this time period, which may start being computed as the calculation flag signal 202 transitions to “1”) then decision device 210 sets status signal 211 to a value of “2” in step 460. However, if the value of lock signal 209 is equal to a “0” and occurs within the Δ_{T} 208 time period (the equalizer has not yet locked within the time period) then decision device 210 sets status signal 211 to a value of “3” in step 425.

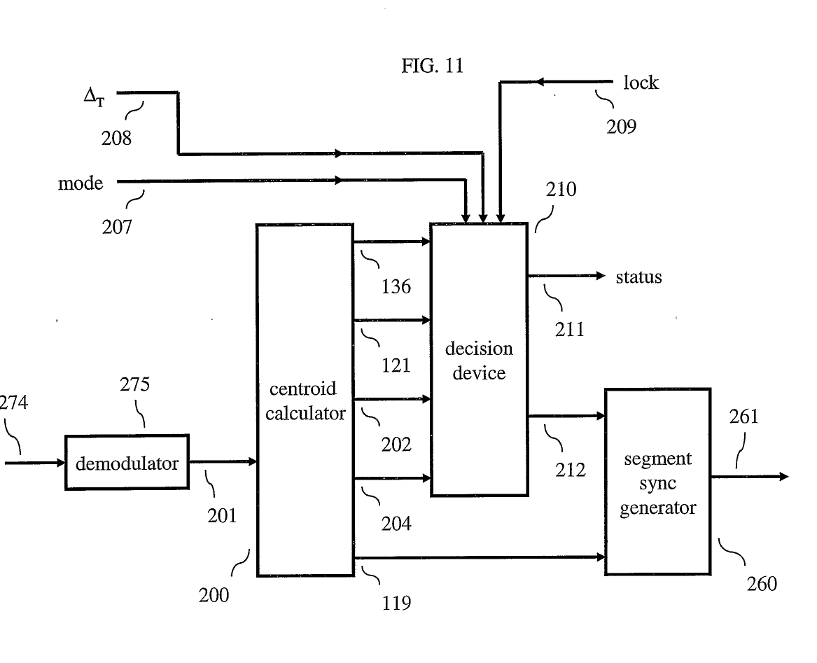

Turning now to FIG. 11, another illustrative embodiment in accordance with the principles of the invention is shown. The embodiment shown in FIG. 11 is similar to that shown in FIG. 8 except that decision device 210 is not dependent on threshold signal 206.

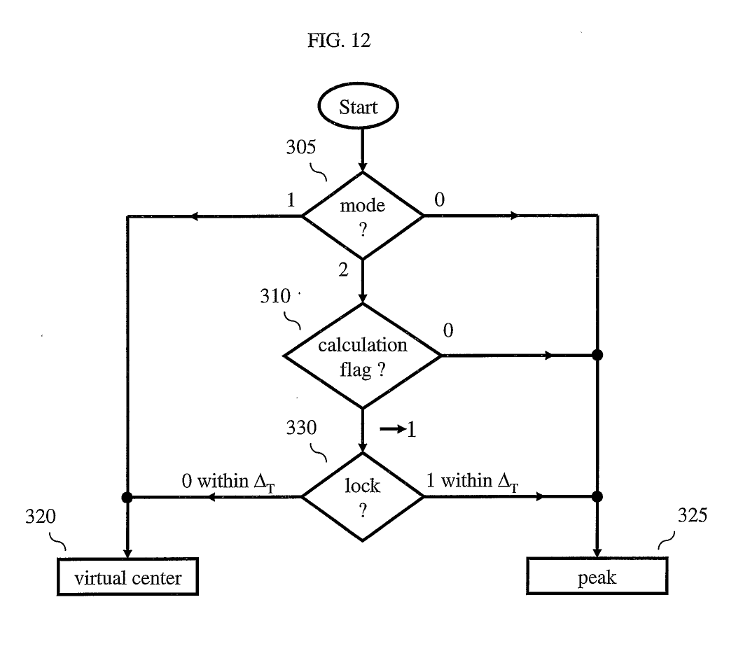

In this embodiment, decision device 210 provides segment reference signal 212 as illustrated in the flow chart of FIG. 12. This flow chart is similar to the flow chart shown in FIG. 9. In step 305 of FIG. 12, decision device 210 determines the current mode of operation from mode signal 207. If mode signal 207 is representative of a value of “0”, then decision device 210 provides peak signal 121 as segment reference signal 212 in step 325. On the other hand, if mode signal 207 is representative of a value of “1”, then decision device 210 provides virtual center value 136 as segment reference signal 212 in step 320. Finally, if mode signal 207 is representative of a value of “2”, then decision device 210 evaluates the calculation flag signal 202 in step 310. If the value of calculation flag signal 202 is equal to “0”, e.g., centroid calculator 200 has not yet finished determining the virtual center value, then decision device 210 provides peak signal 121 as segment reference signal 212 in step 325. However, once the value of calculation flag signal 202 transitions to “1”, (a transition to “1” is represented by the symbol “→1” in FIG. 12), i.e., the calculation is now complete, then decision device 210 evaluates lock signal 209 in step 330. If the value of lock signal 209 is equal to a “1” and occurs within the Δ_{T} 208 time period (e.g., the equalizer has locked within this time period, which may start being computed as the calculation flag signal 202 transitions to “1”) then decision device 210 provides peak signal 121 as segment reference signal 212 in step 325. However, if the value of lock signal 209 is equal to a “0” and occurs within the Δ_{T} 208 time period (the equalizer has not yet locked within the time period) then decision device 210 provides virtual center value 136 as segment reference signal 212 in step 320.

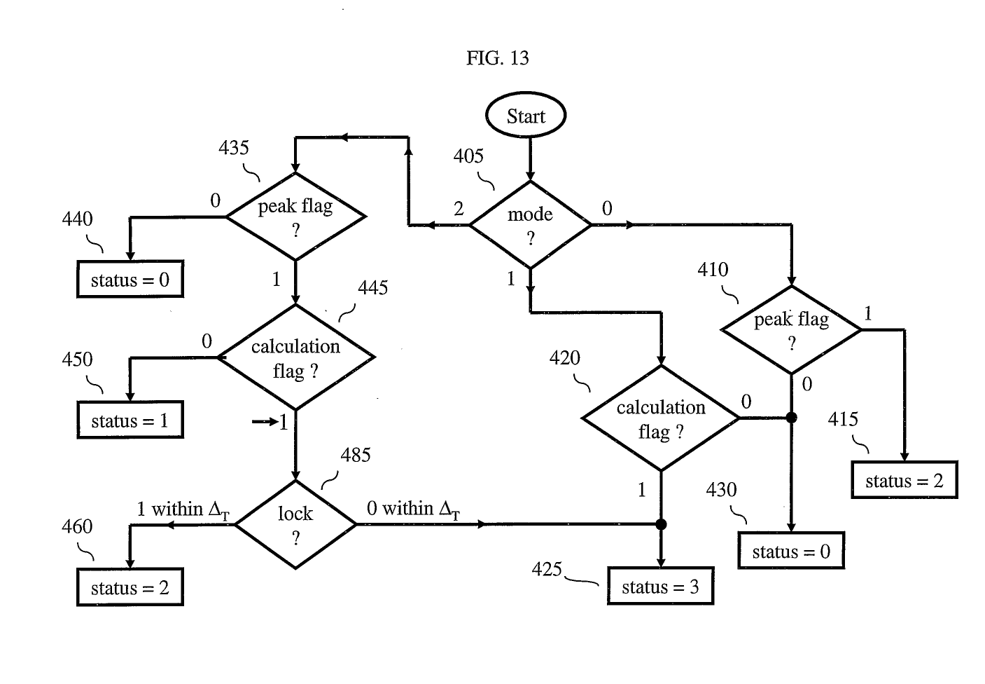

Referring now to FIG. 13, decision device 210 provides status signal 211 as illustrated in the flow chart shown therein. This flow chart is similar to the flow chart shown in FIG. 10. Decision device 210 first determines the mode of operation in step 405. If mode signal 207 is representative of a value of “0”, (peak signal 121 is being used to generate segment reference signal 212) then decision device 210 evaluates peak flag signal 204 in step 410. If the value of peak flag signal 204 is equal to a “1”, i.e., the peak search is complete, then decision device 210 sets status signal 211 to a value of “2” in step 415. However, if the value of peak flag signal 204 is equal to a “0”, i.e., the peak search is not complete, then decision device 210 sets status signal 211 to a value of “0” in step 430. On the other hand, if mode signal 207 is representative of a value of “1”, (virtual center value 136 is being used to generate segment reference signal 212) then decision device 210 evaluates calculation flag signal 202 in step 420. If the value of calculation flag signal 202 is equal to a “1”, i.e., the calculation is complete, then decision device 210 sets status signal 211 to a value of “3” in step 425. However, if the value of calculation flag signal 202 is equal to a “0”, i.e., the calculation is not complete, then decision device 210 sets status signal 211 to a value of “0” in step 430. Finally, if mode signal 207 is representative of a value of “2”, (either peak signal 121 or virtual center value 136 is used for generating the segment sync signal) then decision device 210 evaluates peak flag signal 204 in step 435. If the value of peak flag signal 204 is equal to a “0”, i.e., the peak search is not complete, then decision device 210 sets status signal 211 to a value of “0” in step 440. However, if the value of peak flag signal 204 is equal to a “1”, i.e., the peak search is complete, then decision device 210 evaluates calculation flag 202 in step 445. If the value of calculation flag signal 202 is equal to a “0”, i.e., the calculation is not complete, then decision device 210 sets status signal 211 to a value of “1” in step 450. However, once the value of calculation flag signal 202 transitions to “1”, (a transition to “1” is represented by the symbol “→1” in FIG. 13), i.e., the calculation is now complete, then decision device 210 evaluates lock signal 209 in step 485. If the value of lock signal 209 is equal to a “1” and occurs within the Δ_{T} 208 time period (e.g., the equalizer has locked within this time period, which may start being computed as the calculation flag signal 202 transitions to “1”) then decision device 210 sets status signal 211 to a value of “2” in step 460. However, if the value of lock signal 209 is equal to a “0” and occurs within the Δ_{T} 208 time period (the equalizer has not yet locked within the time period) then decision device 210 sets status signal 211 to a value of “3” in step 425.

All the illustrative embodiments described herein in accordance with the principles of the invention can be based on any sync signal. The correlator compares the input data with the sync signal of choice. In the context of ATSC-DTV, some candidates are the segment sync signal or the frame sync signal. For these types of sync signals the difference is in the choice of the correlator and in the size of the integrators to accommodate the type and size of the sync signal.

Likewise, all of the illustrative embodiments described herein in accordance with the principles of the invention can be based on any type training signal of any digital communications system. In this case, the correlator compares the input data with the training signal in question. For all the embodiments described herein in accordance with the principles of the invention, the virtual center calculation certainly happens at the beginning of signal reception, but the process can continue on so that the optimum virtual center position is constantly updated based on the channel conditions and the virtual center can be shifted according to the updated virtual center position by slowly changing the sampling clock frequency accordingly. The same updates should then be made for the time phase output.

As described above, and in accordance with the principles of the invention, dual-mode generator permits a segment sync generator and/or a frame sync generator to be either based solely on a segment/field sync correlator or on the channel virtual center value as well. The inventive concept may be used in conjunction with the equalizer to speed up the receiver response for the majority of the input signals. The inventive concept may be extended to any training signal of systems subject to linear distortion.

The foregoing merely illustrates the principles of the invention and it will thus be appreciated that those skilled in the art will be able to devise numerous alternative arrangements which, although not explicitly described herein, embody the principles of the invention and are within its spirit and scope. For example, although illustrated in the context of separate functional elements, these functional elements may be embodied on one or more integrated circuits (ICs). Similarly, although shown as separate elements, any or all of the elements of may be implemented in a stored-program-controlled processor, e.g., a digital signal processor, which executes associated software, e.g., corresponding to one or more of the steps shown in, e.g., FIG. 6, etc. Further, although shown as elements bundled within TV set 10, the elements therein may be distributed in different units in any combination thereof. For example, receiver 15 of FIG. 4 may be a part of a device, or box, such as a set-top box that is physically separate from the device, or box, incorporating display 20, etc. Also, it should be noted that although described in the context of terrestrial broadcast, the principles of the invention are applicable to other types of communications systems, e.g., satellite, cable, etc. It is therefore to be understood that numerous modifications may be made to the illustrative embodiments and that other arrangements may be devised without departing from the spirit and scope of the present invention as defined by the appended claims.

1. A receiver, comprising:
a sync generator for providing a synchronization signal;
wherein the sync generator comprises at least two modes of operation, wherein in a first mode of operation the sync generator generates the synchronization signal as a function of a channel virtual center signal and in a second mode of operation the sync generator generates the synchronization signal as a function of a correlation signal.

2. The receiver of claim 1, wherein the synchronization signal represents an ATSC-DTV (Advanced Television Systems Committee-Digital Television) segment sync signal.

3. The receiver of claim 1, wherein the synchronization signal represents an ATSC-DTV (Advanced Television Systems Committee-Digital Television) frame sync signal.

4. The receiver of claim 1, further comprising:
a centroid calculator responsive to a demodulated signal for providing the channel virtual center signal and the correlation signal.

5. The receiver of claim 1, further comprising:
a correlator responsive to a demodulated signal for providing the correlation signal, which is representative of a correlation between a demodulated signal and a data pattern representing the synchronization signal.

6. The receiver of claim 1, further comprising:
a centroid calculation loop for providing the channel virtual center signal as a function of a data pattern conveyed within a demodulated signal, wherein the data pattern is representative of the synchronization signal.

7. The receiver of claim 1, wherein the sync generator generates the synchronization signal as a function of a difference between a value of the channel virtual center signal and a value that is a function of the correlation signal.

8. The receiver of claim 1, wherein the sync generator generates the synchronization signal as a function of a lock signal, the lock signal representing a lock status of at least one of an equalizer, another receiver block or the value of a programmable bit register controlled by a microprocessor.

9. The receiver of claim 1, wherein the sync generator generates the synchronization signal as a function of a lock signal occurring within a time interval, ΔT, the lock signal representing a lock status of at least one of an equalizer, another receiver block or the value of a programmable bit register controlled by a microprocessor.

10. The receiver of claim 1, further comprising:
a decision device for setting the sync generator mode as a function of at least one of the following:
a difference between a value of the channel virtual center signal and a value that is a function of the correlation signal;
a lock signal; a peak calculation flag, which indicates when a correlation calculation is complete; or
a centroid calculation flag, which indicates when a channel virtual center calculation is complete.

11. The receiver of claim 1, further comprising:
a decision device for providing a status signal as a function of at least one of the following:
the sync generator mode;
a difference between a value of the channel virtual center signal and a value that is a function of the correlation signal;
a lock signal;
a peak calculation flag, which indicates when a correlation calculation is complete; or
a centroid calculation flag, which indicates when a channel virtual center calculation is complete.

12. A method for use in a receiver, the method comprising:
providing a synchronization signal in a first mode as a function of a channel virtual center signal; and
providing the synchronization signal in a second mode as a function of a correlation signal.

13. The method of claim 12, wherein the synchronization signal represents an ATSC-DTV (Advanced Television Systems Committee-Digital Television) segment sync signal.

14. The method of claim 12, wherein the synchronization signal represents an ATSC-DTV (Advanced Television Systems Committee-Digital Television) frame sync signal.

15. The method of claim 12, further comprising:
processing a demodulated signal to provide the channel virtual center signal and the correlation signal.

16. The method of claim 12, further comprising:
providing the correlation signal, which is representative of a correlation between a demodulated signal and a data pattern representing the synchronization signal.

17. The method of claim 12, further comprising:
providing the channel virtual center signal as a function of a data pattern conveyed within a demodulated signal, wherein the data pattern is representative of the synchronization signal.

18. The method of claim 12, further comprising
providing the synchronization signal as a function of a difference between a value of the channel virtual center signal and a value that is a function of the correlation signal.

19. The method of claim 12, further comprising
providing the synchronization signal as a function of a lock signal, the lock signal representing a lock status of at least one of an equalizer, another receiver block or the value of a programmable bit register controlled by a microprocessor.

20. The method of claim 12, further comprising
providing the synchronization signal as a function of a lock signal occurring within a time interval, ΔT, the lock signal representing a lock status of at least one of an equalizer, another receiver block or the value of a programmable bit register controlled by a microprocessor.

21. The method of claim 12, further comprising:
setting the sync generator mode as a function of at least one of the following:
a difference between a value of the channel virtual center signal and a value that is a function of the correlation signal;
a lock signal;
a peak calculation flag, which indicates when a correlation calculation is complete; or
a centroid calculation flag, which indicates when a channel virtual center calculation is complete.

22. The method of claim 12, further comprising:
providing a status signal as a function of at least one of the following:
the sync generator mode;
a difference between a value of the channel virtual center signal and a value that is a function of the correlation signal;
a lock signal;
a peak calculation flag, which indicates when a correlation calculation is complete; or
a centroid calculation flag, which indicates when a channel virtual center calculation is complete.
